(19) United States
(12) Patent Application Publication
(10) Pub. No.: US 2011/0205346 A1
(43) Pub. Date: Aug. 25, 2011

(54) 3D IMAGE CONTROL APPARATUS AND CONTROL METHOD THEREOF

(75) Inventor: Osamu Taniguchi, Chigasaki-shi (JP)

(73) Assignee: CANON KABUSHIKI KAISHA, Tokyo (JP)

(21) Appl. No.: 13/032,906

(22) Filed: Feb. 23, 2011

(30) Foreign Application Priority Data
Feb. 24, 2010 (JP) 2010-039069

(51) Int. Cl. H04N 13/04

(52) U.S. Cl. 348/56; 348/E13.074; 348/E13.001

(57) ABSTRACT

In a 3D image viewing system of field sequential type using a liquid crystal apparatus, an apparatus generates a black field that is a period for displaying a black image, which is located between a right field that is a right eye image display period and a left field that is a right eye image display period. Right and left shutters of shutter glasses start to open in synchronization with start of the right and left fields and start to close in synchronization with end of the adjacent black field.

### BACKGROUND OF THE INVENTION

1. Field of the Invention

The present invention relates to a three-dimensional (3D) image control apparatus capable of providing displayed images as 3D images to a viewer and a control method thereof.

2. Description of the Related Art

A 3D image viewing system capable of providing 3D images to the viewer is known that alternately displays right eye images and left eye images in a time-division manner with an image display apparatus to view the images through shutter glasses alternately opening and closing a right shutter and a left shutter in synchronization with switching of the display.

When a liquid crystal display (LCD) is used as an image display apparatus in such a 3D image display system of a field sequential (FS) type, crosstalk of images in which a mixture of the right eye image and left eye image are viewed has become problematic. Japanese Patent Application Laid-Open No. 2009-230071 discusses a shutter glasses system described below. While a time point for opening a shutter of shutter glasses and an opening period thereof are being slid, the time point for opening the shutter and the opening period thereof that are ideal for acquiring the images having the least mixture is detected using a color sensor.

Further, Japanese Patent Application Laid-Open No. 2009-031523 discusses a 3D image display apparatus that suppresses crosstalk by alternately displaying the right eye image and the left eye image every two frames.

However, the conventional LCD 3D image viewing system does not realize ensuring luminance of an observed image and canceling image crosstalk sufficiently at a time.

### SUMMARY OF THE INVENTION

According to an aspect of the present invention, an apparatus configured to provide a 3D image to be viewed by causing a display unit that displays an image on a screen by sequentially selecting scanning lines to alternately display a right eye image and a left eye image in a time-division manner and by, in synchronization with switching of the right and the left eye images, alternately opening and closing right and left shutters of shutter glasses includes an input unit configured to input an image signal for displaying the 3D image, a processing unit configured to generate a right eye image signal, a left eye image signal, and a black image signal from the input image signal, a transmission unit configured to transmit a synchronization signal synchronized with switching of the right and the left eye images to the shutter glasses, and a control unit configured to control the processing unit and the transmission unit in association with each other. The display unit is a hold type display unit that displays the 3D image by a frame formed of a right field that is a period for addressing scanning lines to display the right eye image, a left field that is a period for addressing scanning lines to display the left eye image, and a black field, located between the right field and the left field, that is a period for addressing scanning lines to display a black image. The transmission unit transmits the synchronization signal such that the right shutter starts to open in synchronization with start of the right field and starts to close in synchronization with end of the black field located after the right field, and the left shutter starts to open in synchronization with start of the left field and starts to close in synchronization with end of the black field located after the left field.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram of a 3D image viewing system according to an exemplary embodiment of the present invention.

FIGS. 2A, 2B, and 2C are explanatory diagrams for explaining relationships between scanning line addressing by a liquid crystal display apparatus and shutter opening periods of shutter glasses according to an exemplary embodiment of the present invention.

FIG. 3 is an explanatory diagram for explaining shutter opening and closing timings of shutter glasses according to an exemplary embodiment of the present invention.

FIGS. 4A and 4B are explanatory diagrams for explaining image crosstalk.

FIGS. 5A, 5B, and 5C are explanatory diagrams for explaining relationships between scanning line addressing by an LCD apparatus and shutter opening periods of shutter glasses according to another exemplary embodiment of the present invention.

FIG. 6 is an explanatory diagram for explaining relationships between scanning line addressing by an electroluminescence (EL) display apparatus and shutter opening periods of shutter glasses according to an yet another exemplary embodiment of the present invention.

### DESCRIPTION OF THE EMBODIMENTS

Various exemplary embodiments, features, and aspects of the invention will be described in detail below with reference to the drawings.

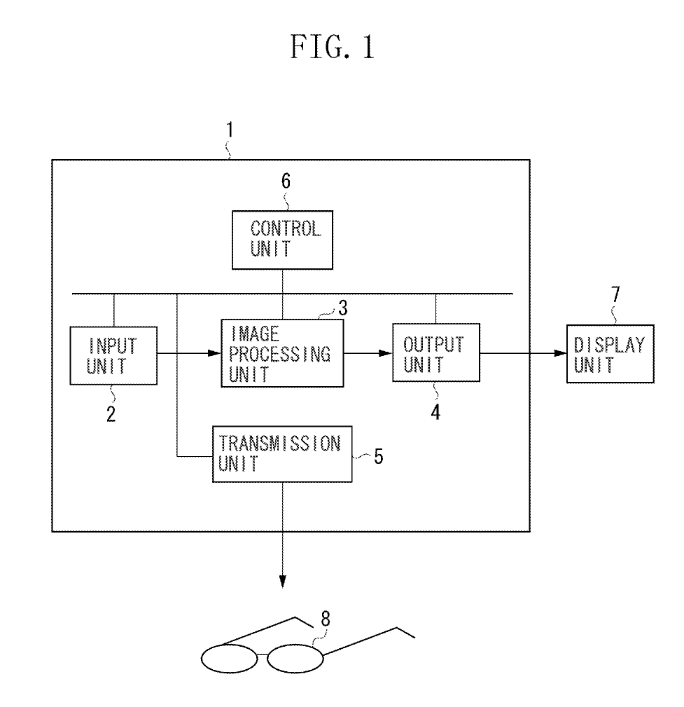

FIG. 1 is block diagram of a 3D image viewing system according to an exemplary embodiment of the present invention, which includes a 3D image control apparatus 1, a display unit 7, and shutter glasses (hereafter, referred to as “glasses”) 8. The 3D image control apparatus 1 is any one of a video recorder, a set top box (STB), or a 3D image television set (3DTV) integrated with the display unit 7.

An input unit 2 inputs 3D image signals from an image source. The image source includes an image content distribution system via digital broadcasting or the Internet and an external image device such as a video player.

The input 3D image signals are separated by an image processing unit 3 into a right eye image signal, a left eye image signal, and a synchronization signal for controlling shutter glasses (hereafter, referred to as “synchronization signal”). The synchronization signal is transmitted from a transmission unit 5 to the glasses 8 via a communication medium of an infrared communication or a wireless communication. A control unit (not illustrated) of the glasses 8 controls opening and closing right and left shutters in synchronization with the received synchronization signal.

An output unit 4 converts the right and left eye image signals input from the image processing unit 3 into display data for displaying the 3D image conforming to the specifications of the display unit 7 and outputs the display data to the display unit 7. Based on right eye display data and left eye display data, the display unit 7 alternately displays the right eye image and the left eye image for each field, which is obtained by dividing a frame in a time-division manner.

A control unit 6 responds to a user's operation performed via a remote controller and controls each block in association with each other as described below. When the user selects digital broadcasting as an image source, the control unit 6 sets the input unit 2 to digital broadcasting input and receives broadcasting signals of the channel selected by the user. The input unit 2 includes a digital tuner as an input interface from the external.

The control unit 6 refers to program information previously acquired via the digital broadcasting and determines whether a selected program on-air in the received channel is a 3D program. When the selected program is a 3D program, the control unit 6 causes the image processing unit 3 to switch from normal image processing for 2D image signals to image processing for 3D image signals. Further, the control unit 6 controls the transmission unit 5 to transmit the synchronization signal to the glasses 8.

The user can view 3D content by viewing the 3D image displayed on the display unit 7 as an observed image through the shutter glasses 8.

The display unit 7 sequentially scans scanning lines and applies a signal pulse based on display data to a signal line in synchronization with scanning so as to display an image on a screen. As the display unit 7, a liquid crystal display apparatus of an active matrix type (hereafter, referred to as “LCD”) adopting hold type display of a scanning addressing synchronization type is used. The scanning addressing synchronization type lights a pixel (addressed pixel) on the selected scanning line with luminance that matches with the display data in synchronization with addressing of the scanning line. As with a plasma display panel, a scanning addressing non-synchronization type adopts a display method in which addressing of the scanning line differs from a lighting period of the pixel. A display screen has the number of pixels 1920×1080, and a display frame rate (refresh rate) is 240 Hz. Further, a hold type display is a display method for substantially holding the luminance of the addressed pixel until being addressed next time.

According to the present exemplary embodiment, one frame is defined as an addressing period including both of the right eye image and the left eye image. Each addressing period of the right eye image and the left eye image is defined as a right field “R” and a left field “L”.

The glasses 8 are liquid crystal shutter glasses and use a liquid crystal element of a twisted nematic (TN) type or alight scattering type. Further, the glasses 8 use a normally white mode in which the shutter changes from “Open” to “Closed” by applying an electric field to a liquid crystal layer and then from “Closed” to “Open” by canceling the electric field. Furthermore, start of opening and closing of the shutter is synchronized with rising and falling of a pulse of the synchronization signal generated in response to an instruction from the control unit 6.

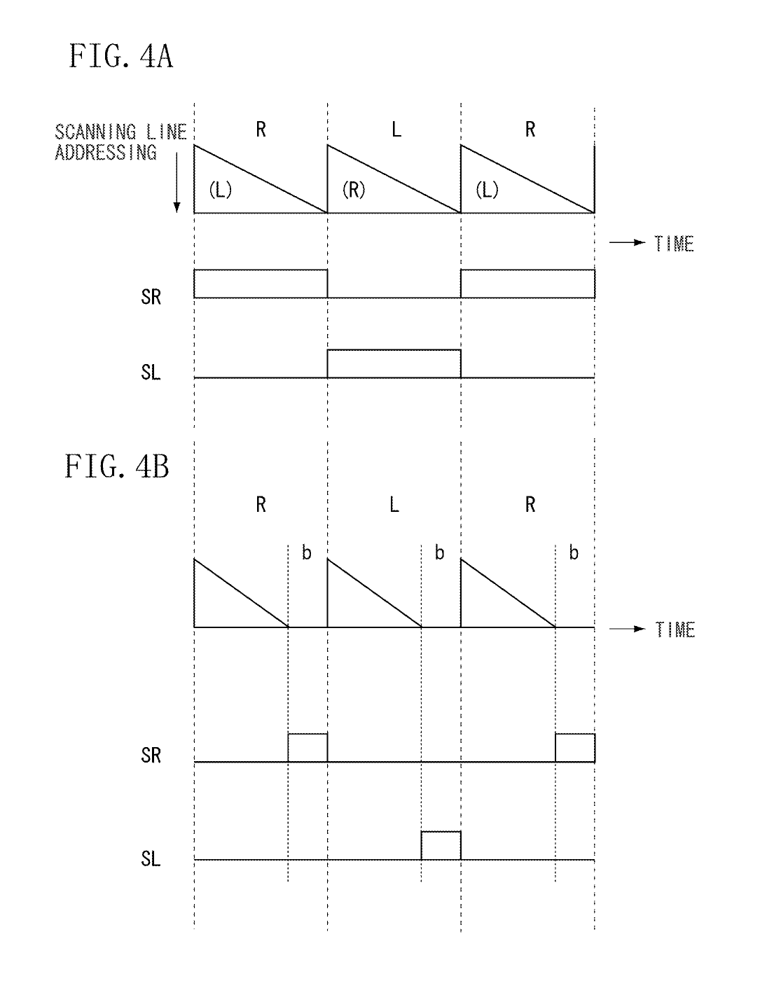

FIGS. 4A and 4B illustrate relationships between scanning addressing in each field and shutter opening and closing timings. The LCD is alternately scanned in the right field “R” and the left field “L”.

FIG. 4A illustrate that the right shutter SR and the left shutter SL become in an open state in synchronization with the right field “R” and the left field “L”, respectively. With such synchronization control, an “L” field image (L) of a just previous field mixes into the right field “R”, and an “R” field image (R) of a just previous field mixes into the left field “L”.

FIG. 4B illustrates an example in which the right and left shutters are respectively opened only during vertical blanking periods (hereafter, referred to as “blanking periods”) “b” located at rear portions of the respective right field “R” and left field “L”. Since the observed image is formed only during the blanking periods, a backlight of the LCD is lit during the blanking periods and extinguished during other periods. In such synchronization control, the image of the just previous field can be avoided from being mixed. However, the period for observing the displayed image becomes extremely short, thereby deteriorating the luminance of the observed image.

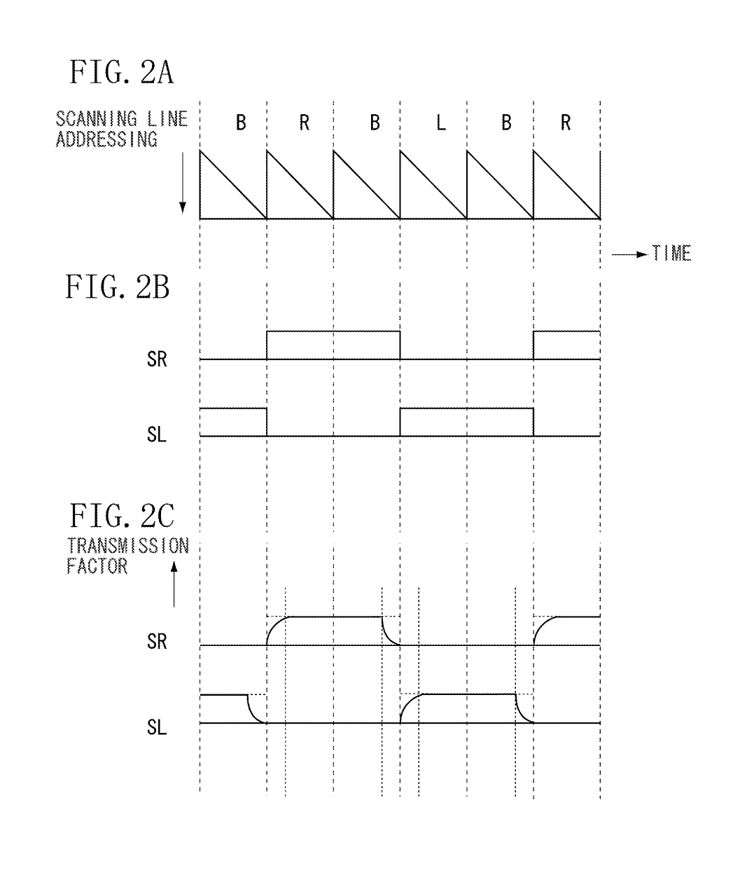

FIGS. 2A, 2B, and 2C illustrates relationships between timings of scanning addressing of the LCD and timings of opening and closing of the shutters according to the present exemplary embodiment of the present invention. Between the right field “R” and the left field “L”, a black field “B” for displaying black is inserted. The blanking period “b” located between fields is not illustrated. In the black field “B”, in addition to the input 3D image signal, a black image signal for displaying black generated in the apparatus is output to the display unit 7 as the display data.

FIG. 2A illustrates timings of scanning addressing in each field. The scanning lines are sequentially selected from the top portion to the bottom portion on the display screen. More specifically, a gate signal is sequentially applied for each scanning line at a gate of a thin film transistor (TFT) disposed for a pixel disposed on each scanning line. Each field is scanned progressively, and the field frequency is 240 Hz

One frame is formed of four fields, which are a right field “R”, a left field “L”, and two black fields “B”, and, thus, the frame rate is 60 Hz. Each of the right field “R”, the left field “L”, and the black field “B” has the equal field period. By applying a source signal corresponding to the display data in synchronization with the gate signal, the liquid crystal responds accordingly.

FIG. 2B illustrates the opening and closing timings of the right shutter SR and the left shutter SL of the glasses. The vertical axis represents transmission factors of the shutters. A state where the transmission factor is the largest is a state where the shutter is open (a state where the transmission factor is the smallest, a state where the shutter is closed). The right shutter SR starts to open in synchronization with start of the right field “R” and starts to close in synchronization with end of the black field “B” following the right field “R”. Likewise, the left shutter SL starts to open in synchronization with start of the left field “L” and starts to close in synchronization with end of the black field “B” following the left field “L”

Further, in synchronization with start of the black field adjacent to a heading portion of each of the right and left fields, the right and left shutter may open, and, in synchronization with each end of the right and left fields following the black field, the right and left shutters may close.

By performing synchronization control as described above, an image written in the just previous field is deleted with a black image. Accordingly, the image illustrated in FIG. 4A is avoided to be mixed into the following field. Further, since the display image is observed during the display period for one field, the luminance of the observed image can be ensured.

The right field period is equal to the left field period. However, the black field period do not have to be equal to the right and left periods. The black field period may be set to ¼ to ¾ of the right or left field period.

A second exemplary embodiment of the present invention is directed to controlling timing for starting to open and close the shutter according to a response time of the shutter of the glasses.

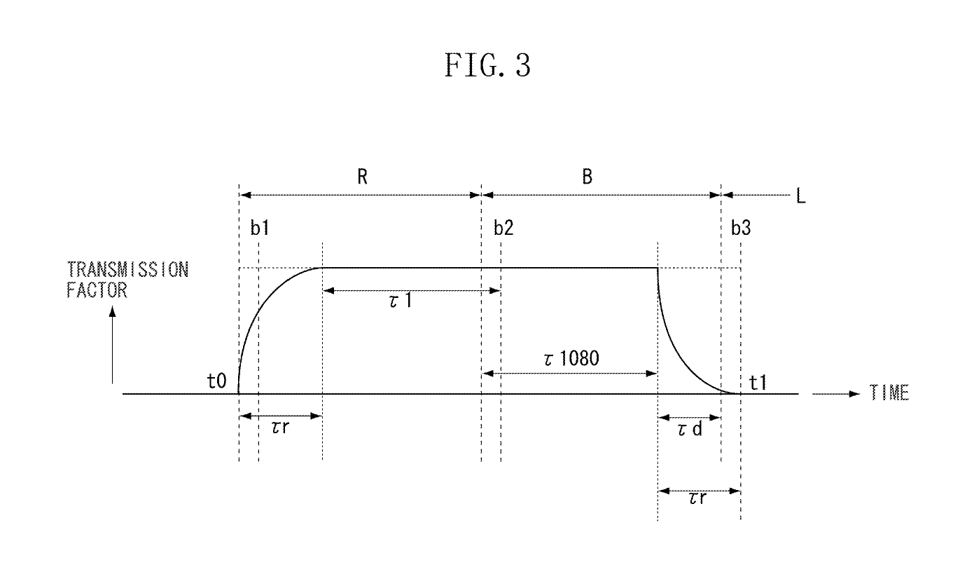

FIG. 2C illustrates start timing of opening and closing of the right and left shutters in each field and a response state (the blanking period is not illustrated). Further, FIG. 3 illustrates details of the start timing of opening and closing of the right shutter SR and the response state. At each of the heading portions of the right field and the black field of the LCD, the blanking period “b” is disposed (500 μsec).

Regarding a response time of the liquid crystal element constituting the shutter, a falling time τd is shorter than a rising time τr in the normally white mode, which are 1 msec and 2 msec, respectively. When it is defined that the minimum transmission factor of the shutter is to be 0% and the maximum transmission factor is to be 100%, the rising time τr and the falling time τd are the time for reaching from the transmission factor 10% to 90% and the time for reaching from the transmission factor 90% to 10%, respectively.

The right shutter SR starts to open in synchronization with a start point t0 of a blanking period b1 located at a heading portion of the right field “R” and becomes an open state after the rising time τr has elapsed. The right shutter SR starts to close at a time point the rising time τr earlier than an end time point t1 of a blanking time b3 in the left field “L” following the black field “B” adjacent to an end portion of the right field “R”. In other words, the right shutter SR starts to close at a time point a time period, obtained by subtracting the blanking time b3 from the rising time τr, earlier than the end point of the black field “B”.

Likewise, the left shutter SL starts to open in synchronization with a start point of a blanking period located at a heading portion of the left field “L”, and becomes an open state after the rising time τr has elapsed. The left shutter SL starts to close at a time point the rising time τr earlier than an end time point t1 of a blanking time in the right field “R” following the black field “B” adjacent to an end portion of the left field “L”.

As described above, by controlling start of opening and closing of the shutter, the observation period τ1 of the pixel on the scanning line at the heading portion of the field becomes equal to the observation period τ1080 of the pixel of the scanning line at the end portion of the field. However, the observation period of the pixel on the scanning line near a middle portion is longer than the period τ1 (τ1080). Thus, the time point of starting to close may be delayed a predetermined time than that described above so that a difference between the observation periods is not outstanding in an entire observation image screen. The time point t2 of starting to close the shutter may be set earlier a time amount between the time point t1 of end of the blanking period b3 and the rising time (τr) and the time (τr/2), as expressed by the following equation.

t1−τr≦t2≦t1−τr/2

As described above, the shutter starts to open in synchronization with start of the blanking period in each of the right and left fields, and starts to close a predetermined time earlier than the end time point of the adjacent black field, so that the observation periods of the pixel on each scanning line are uniformed. Accordingly, a 3D display image having a uniform luminance in the entire screen can be observed.

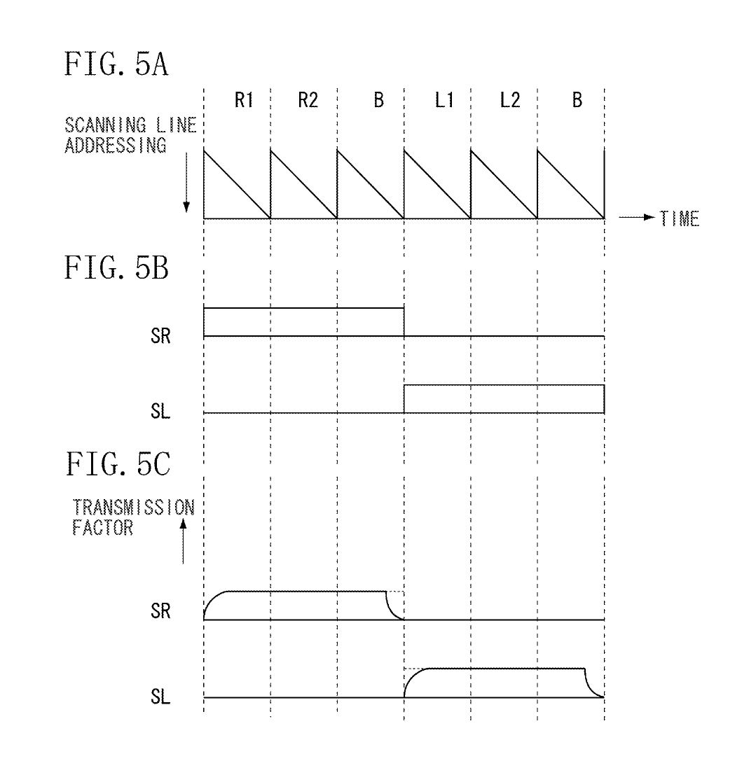

FIGS. 5A and 5B illustrate relationships between timing of scanning addressing of the LCD and timing of opening and closing of shutters of the glasses according to a third exemplary embodiment of the present invention.

The black field is located between two consecutive right fields and two consecutive left fields. The right shutter SR starts to open in synchronization with start of a former right field R1 and starts to close in synchronization with end of the black field “B” following a latter right field R2. Likewise, the left shutter SL starts to open in synchronization with start of a former left field L1 and starts to close in synchronization with end of the black field “B” following a latter left field L2.

In the right fields R1 and R2, the same right eye image data based on the right eye image signal for one field may be output onto the LCD twice, or different pieces of right eye image data based on the right eye image signal for two fields may be output separately. In the left fields L1 and L2, the left eye image data may be output in a similar manner.

As described above, by controlling the timing, even when the liquid crystal of the LCD responds slow, the luminance of the image observation screen can be uniformed.

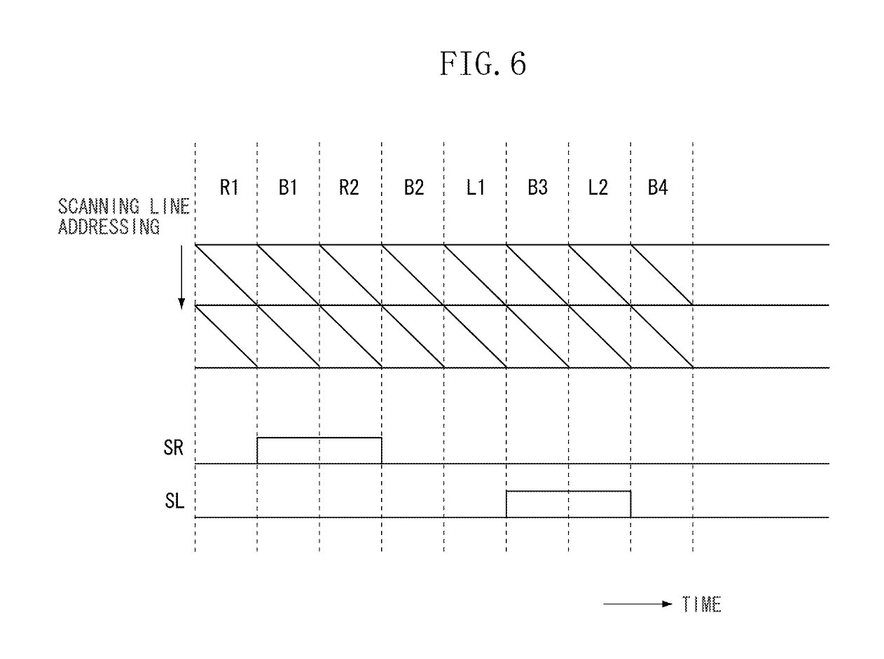

FIG. 6 illustrates relationships between scanning addressing timing of an organic light emitting display (OLED) and timing of opening and closing of shutters of the glasses according to a fourth exemplary embodiment of the present invention.

A display panel is used of an active matrix type for the OLED. In a middle of scanning addressing, semi-hold type display having a duty of ½ for starting a reset operation is used. More specifically, semi-hold type display does not hold the luminance applied to a pixel addressed by scanning addressing until the pixel is addressed next but resets the luminance on the way of scanning addressing. The duty represents the ratio of the period from starting scanning addressing to starting a reset operation to the scanning addressing period. The held image is deleted by the reset operation, and a black image is displayed.

Respective fields are disposed in order of, for example, the right field R1, the black field B1, the right field R2, the black field B2, the left field L1, the black field B3, the left field L2, and the black field B4. Progressive scanning is performed in each field. The right shutter SR starts to open in synchronization with start of the black field B1 following the right field R1 or end of the black field just previous to the right field R1, and starts to close in synchronization with end of the black field B1 or start of the next black field B2. Likewise, the left shutter SL starts to open in synchronization with start of the black field B3 or end of the black filed B2, and starts to close in synchronization with end of the black field B3 or start of the black field B4.

In the right fields R1 and R2, the same right eye image data based on the right eye image signal for one field is output to the OLED twice. More specifically, the same right eye image is displayed on the right fields R1 and R2. The same left eye image is displayed on the left fields L1 and L2 in a similar manner. One frame is formed of eight fields R1, B1, R2, B2, L1, B3, L2, and B4, and corresponds to one screen as a 3D image.

As described above, by controlling the timing, crosstalk can be suppressed and the display period in the image observation screen can be uniformed, and thus the luminance in the image observation screen can be uniformed.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-039069 filed Feb. 24, 2010, which is hereby incorporated by reference herein in its entirety.

What is claimed is:

1. An apparatus configured to provide a 3D image to be viewed by causing a display unit that displays an image on a screen by sequentially selecting scanning lines to alternately display a right eye image and a left eye image in a time-division manner and by, in synchronization with switching of the right and the left eye images, alternately opening and closing right and left shutters of shutter glasses, the apparatus comprising:
an input unit configured to input an image signal for displaying the 3D image;
a processing unit configured to generate a right eye image signal, a left eye image signal, and a black image signal from the input image signal;
a transmission unit configured to transmit a synchronization signal synchronized with switching of the right and the left eye images to the shutter glasses; and
a control unit configured to control the processing unit and the transmission unit in association with each other,
wherein the display unit is a hold type display unit that displays the 3D image by a frame formed of a right field that is a period for addressing scanning lines to display the right eye image, a left field that is a period for addressing scanning lines to display the left eye image, and a black field, located between the right field and the left field, that is a period for addressing scanning lines to display a black image, and
wherein the transmission unit transmits the synchronizing signal such that the right shutter starts to open in synchronization with start of the right field and starts to close in synchronization with end of the black field located after the right field, and the left shutter starts to open in synchronization with start of the left field and starts to close in synchronization with end of the black field located after the left field.

2. The apparatus according to claim 1, wherein a vertical blanking period is located at a heading portion of each of the fields,
wherein the right shutter starts to open in synchronization with start of the vertical blanking period in the right field and starts to close at a time point a predetermined time earlier than an end time point of the black field located after the right field, and
wherein the left shutter starts to open in synchronization with start of the vertical blanking period in the left field and starts to close at a time point the predetermined time earlier than an end time point of the black field located after the left field.

3. The apparatus according to claim 2, wherein the predetermined time is a rising time corresponding to a time from when the right shutter or the left shutter starts to open to when the right shutter or the left shutter reaches an open state.

4. The apparatus according to claim 3, wherein the predetermined time is a time obtained by subtracting the vertical blanking period from the rising time.

5. The apparatus according to claim 1, wherein the display unit is a liquid crystal display apparatus of active matrix type.

6. An apparatus configured to provide a 3D image to be viewed by causing a display unit that displays an image on a screen by sequentially selecting scanning lines to alternately display a right eye image and a left eye image in a time-division manner and by, in synchronization with switching of the right and the left eye images, alternately opening and closing right and left shutters of shutter glasses, the apparatus comprising:
an input unit configured to input an image signal for displaying the 3D image;
a processing unit configured to generate a right eye image signal, a left eye image signal, and a black image signal from the input image signal;
a transmission unit configured to transmit a synchronization signal synchronized with switching of the right and the left eye images to the shutter glasses; and
a control unit configured to control the processing unit and the transmission unit in association with each other,
wherein the display unit is a semi hold type display unit that displays the 3D image by a frame formed of a right field that is a period for addressing scanning lines to display the right eye image, a left field that is a period for addressing scanning lines to display the left eye image, and a black field that is a period for addressing scanning lines to display a black image,
wherein the frame includes at least two right fields that display a same right eye image and at least two left fields that display a same left eye image, and the black field is located between the at least two right fields, between the at least two left fields, and between the right field and the left field, and
wherein the transmission unit transmits the synchronizing signal such that the right shutter starts to open in synchronization with start of the black field located between the right fields or end of the black field located between the right field and left field and starts to close in synchronization with end of the black field located between the right fields or start of the black field located between the right field and the left field, and the left shutter starts to open in synchronization with start of the black field located between the left fields or end of the black field located between the right field and the left field and starts to close in synchronization with end of the black field located between the left fields or start of the black field located between the right field and left field.

7. The apparatus according to claim 6, wherein a vertical blanking period is located at a heading portion of each of the fields,
wherein the right shutter starts to open in synchronization with start of the vertical blanking period in the right field and starts to close at a time point a predetermined time earlier than an end time point of the black field located after the right field, and
wherein the left shutter starts to open in synchronization with start of the vertical blanking period in the left field and starts to close at a time point the predetermined time earlier than an end time point of the black field located after the left field.

8. The apparatus according to claim 7, wherein the predetermined time is a rising time corresponding to a time from when the right shutter or the left shutter starts to open to when the right shutter or the left shutter reaches an open state.

9. The apparatus according to claim 8, wherein the predetermined time is a time obtained by subtracting the vertical blanking period from the rising time.

10. The apparatus according to claim 6, wherein the display unit is a liquid crystal display apparatus of active matrix type.

11. A method for controlling an apparatus configured to provide a 3D image to be viewed by causing a display unit that displays an image on a screen by sequentially selecting scanning lines to alternately display a right eye image and a left eye image in a time-division manner and by, in synchronization with switching of the right and the left eye images, alternately opening and closing right and left shutters of shutter glasses, the method comprising:
inputting an image signal for displaying the 3D image;
generating a right eye image signal, a left eye image signal, and a black image signal from the input image signal; and
transmitting a synchronization signal synchronized with switching of the right and the left eye images to the shutter glasses,
wherein the display unit is a hold type display unit of scanning addressing synchronization type that displays the 3D image by a frame formed of a right field that is a period for addressing scanning lines to display the right eye image, a left field that is a period for addressing scanning lines to display the left eye image, and a black field, located between the right field and the left field, that is a period for addressing scanning lines to display a black image, and
wherein the right shutter starts to open in synchronization with start of the right field and starts to close in synchronization with end of the black field located after the right field, and the left shutter starts to open in synchronization with start of the left field and starts to close in synchronization with end of the black field located after the left field.

12. The method according to claim 11, wherein a vertical blanking period is located at a heading portion of each of the fields,
wherein the right shutter starts to open in synchronization with start of the vertical blanking period in the right field and starts to close at a time point a predetermined time earlier than an end time point of the black field located after the right field, and
wherein the left shutter starts to open in synchronization with start of the vertical blanking period in the left field and starts to close at a time point the predetermined time earlier than an end time point of the black field located after the left field.

13. The method according to claim 12, wherein the predetermined time is a rising time corresponding to a time from when the right shutter or the left shutter starts to open to when the right shutter or the left shutter reaches an open state.

14. The method according to claim 13, further comprises subtracting the vertical blanking period from the rising time to obtain the predetermined time.

15. The method according to claim 11, wherein the display unit is a liquid crystal display apparatus of active matrix type.

16. A method for controlling an apparatus configured to provide a 3D image to be viewed by causing a display unit that displays an image on a screen by sequentially selecting scanning lines to alternately display a right eye image and a left eye image in a time-division manner and by, in synchronization with switching of the right and the left eye images, alternately opening and closing right and left shutters of shutter glasses, the method comprising:
inputting an image signal for displaying the 3D image;
generating a right eye image signal, a left eye image signal, and a black image signal from the input image signal; and
transmitting a synchronization signal synchronized with switching of the right and the left eye images to the shutter glasses;
wherein the display unit is a semi hold type display unit that displays the 3D image by a frame formed of a right field that is a period for addressing scanning lines to display the right eye image, a left field that is a period for addressing scanning lines to display the left eye image, and a black field that is a period for addressing scanning lines to display a black image,
wherein the frame includes at least two right fields that display a same right eye image and at least two left fields that display a same left eye image, and the black field is located between the at least two right fields, between the at least two left fields, and between the right and the left fields, and
wherein the right shutter starts to open in synchronization with start of the black field located between the right fields or end of the black field located between the right field and left field and starts to close in synchronization with end of the black field located between the right fields or start of the black field located between the right and the left fields, and the left shutter starts to open in synchronization with start of the black field located between the left fields or end of the black field located between the right field and the left field and starts to close in synchronization with end of the black field located between the left fields or start of the black field located between the right and the left fields.

17. The method according to claim 16, wherein a vertical blanking period is located at a heading portion of each of the fields,
wherein the right shutter starts to open in synchronization with start of the vertical blanking period in the right field and starts to close at a time point a predetermined time earlier than an end time point of the black field located after the right field, and
wherein the left shutter starts to open in synchronization with start of the vertical blanking period in the left field and starts to close at a time point the predetermined time earlier than an end time point of the black field located after the left field.

18. The method according to claim 17, wherein the predetermined time is a rising time corresponding to a time from when the right shutter or the left shutter starts to open to when the right shutter or the left shutter reaches an open state.

19. The method according to claim 18, further comprises subtracting the vertical blanking period from the rising time to obtain the predetermined time.

20. The method according to claim 16, wherein the display unit is a liquid crystal display apparatus of active matrix type.
